(19) United States
(12) Patent Application Publication
(10) Pub. No.: US 2022/0016840 A1
(43) Pub. Date: Jan. 20, 2022

(54) 3D PRINTER

(71) Applicant: BioMediCan, Inc., Fremont, CA (US)

(72) Inventor: Maxim Mikheev, Fremont, CA (US)

(73) Assignee: BioMediCan, Inc., Fremont, CA (US)

(21) Appl. No.: 17/413,561

(22) PCT Filed: Dec. 11, 2019
(86) PCT No.: PCT/US2019/065817

§ 371 Date: Jun. 13, 2021

Related U.S. Application Data
(60) Provisional application No. 62/779,000, filed on Dec. 13, 2018.

(51) Int. Cl. B29C 64/295; B33Y 30/00

(52) U.S. Cl. CPC B29C 64/295; B29C 64/386; B33Y 30/00

(57) ABSTRACT

A 3D printer comprising an extruder comprising a heated nozzle for depositing a layer of molten material on to a substrate, and a heating means configured to heat the substrate in an area underneath the heated nozzle of the extruder.

### TECHNICAL FIELD

The present invention relates to a 3D printer.

### BACKGROUND

3D printing or additive manufacturing is the process of building a three-dimensional model or part from a computer aided design (CAD) model, which is typically achieved by successively adding material layer by layer.

One type of 3D printing is fused filament fabrication (FFF) also referred to as fused deposition modelling (FDM), which uses a continuous filament of a thermoplastic material, fed from a large coil, through a moving, heated printer extruder head. Molten material is forced out of the print head's nozzle and is deposited on the growing work piece. The head is moved, under computer control, to define the printed shape. Typically, the print head moves in layers, moving in two dimensions to deposit one horizontal plane at a time, before moving slightly upwards to begin a new layer, wherein the lower layer becomes the substrate for the new (or upper) layer. The speed of the extruder head may also be controlled, to stop and start deposition and form an interrupted plane without stringing or dribbling between sections.

The 3D printer head or 3D printer extruder is the component responsible for melting raw material and forming it into a continuous profile. A wide variety of materials are able to be extruded, including thermoplastics such as acrylonitrile butadiene styrene (ABS), polylactic acid (PLA), high-impact polystyrene (HIPS), thermoplastic polyurethane (TPU), aliphatic polyamides (nylon) and polyether ether ketone (PEEK).

A cross-sectional schematic of an example of a prior art 3D printer is shown in FIG. 1. The printer 1 comprises an extruder 5 which features a cold end comprising a filament motor 7, and a hot end 9 comprising a heated nozzle 11. In use, the filament motor 7 drives a filament 3 toward the hot end 9and heated nozzle 11, where the filament 3 is heated until it becomes molten. As more filament 3 is driven or pushed in to the hot end 9 and heated nozzle 11, the molten material is forced out via the heated nozzle 11. The printer 1 also comprises a heated print bed 13, which provides the substrate on which the printer 1 commences printing of the work piece, and a chamber 15 in which the extruder 5, control means, print bed 13 and associated components are housed. The position of the extruder 5 is directed by a control means capable of controlling the position of the extruder 5 with respect to the print bed 13 in x-y-z coordinates.

In most FFF printers (aside from varying the filament material) there are several parameters which have an influence on printing quality and the resultant material properties of the work piece, including the temperature of the hot end, the temperature of the printing bed; the thickness of each layer of printed material, the speed at which the filament material is fed through the extruder and on to the workpiece, and the temperature inside the printer chamber.

One of the known issues with FFF printing is that the mechanical properties (such as the strength) of the model or part produced are undesirable. However it has been discovered that finished products having adjacent layers that are strongly bonded together, have more favourable mechanical properties. One known method for improving the bond between adjacent layers is to increase the temperature inside the printer chamber. The difficulty with raising the temperature of the printer chamber is that many parts of the printer (such as the cold end of the extruder housing the unmelted filament, and the electronics used to control the position of the extruder) are prone to failure at elevated temperatures.

Another known issue with FFF printing is that when printing with hard materials such as PEEK, a minor over extrusion (supply of more material than is desired) may build up above the printing layer and create a deformation that may prevent the extruder from printing the subsequent layer, or cause the print head to dislodge or move the workpiece from the printing bed, both instances resulting in print failure..

It is against this background, that the present disclosure has been developed.

### SUMMARY

According to a first aspect, there is provided a 3D printer comprising an extruder comprising a heated nozzle for depositing a layer of molten material on to a substrate, and a heating means configured to heat the substrate in an area underneath the heated nozzle of the extruder.

In one form, the heating means comprises a heat source and a convection means, wherein the convection means directs heated air that has been heated by the heating source toward the area underneath the heated nozzle of the extruder.

In one form, the heating means further comprises a heater nozzle, configured to direct a stream of heated air toward the area underneath the heated nozzle of the extruder.

In one form, the heater nozzle is located adjacent to the heated nozzle.

In one form, the heat source is an electrically heated element.

In one form, the convection means comprises a fan.

In one form, the fan is located adjacent to the heat source.

In one form, the fan is located remote from the heat source and is in fluid connection with the heating element via a conduit.

In one form, the heating means is in the form of a laser configured to heat the area underneath the heated nozzle of the extruder.

In one form, the heating means is in the form of an infrared emitter configured to heat the area underneath the heated nozzle of the extruder.

In one form, the heating means further comprises a sensor to measure the temperature of the substrate in the area underneath the heated nozzle of the extruder, in order to provide a feedback loop to the heating means in order to maintain a desired temperature of the substrate.

### BRIEF DESCRIPTION OF DRAWINGS

Embodiments of the present invention will be discussed with reference to the accompanying drawings wherein:

FIG. 1 is a cross-sectional schematic of an example of a prior art 3D printer;

FIG. 2 is a cross-sectional schematic of a portion of a 3D printer, according to an embodiment;

FIG. 3 is a cross-sectional schematic of a portion of a 3D printer, according to an alternative embodiment;

FIG. 4 is a perspective view of a portion of a 3D printer, according to yet another alternative embodiment.

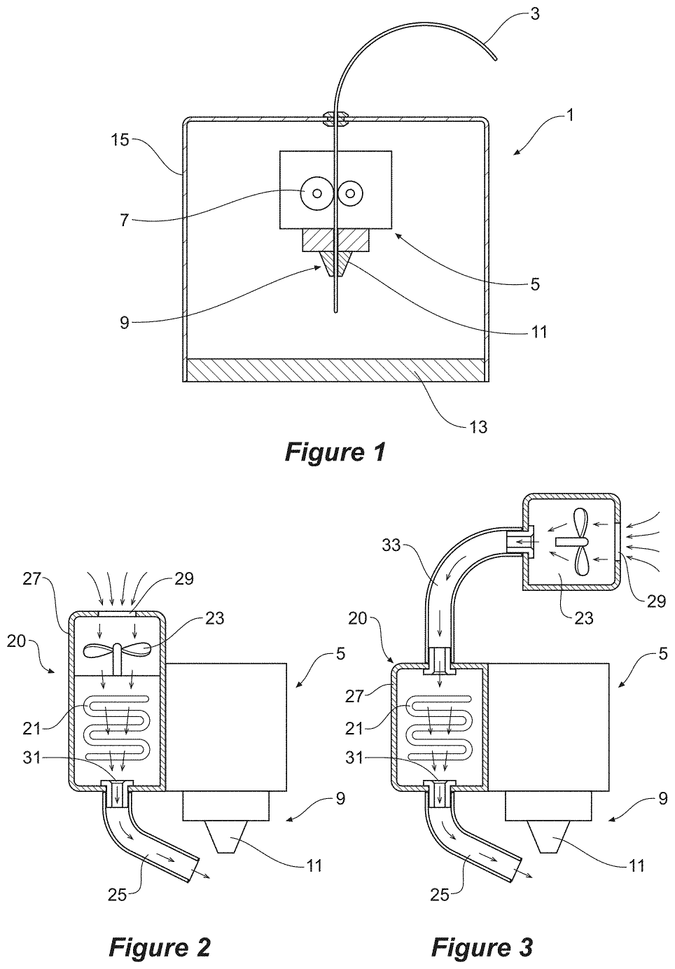

### DESCRIPTION OF EMBODIMENTS

Referring now to FIG. 2, there is shown a cross-sectional schematic of a portion of a 3D printer, according to an embodiment. The printer comprises an extruder 5 comprising a heated nozzle 11 for depositing a layer of molten material on a substrate, and a heating means 20 configured to heat the substrate in an area underneath the heated nozzle 11 of the extruder 5.

The heating means 20 comprises a heat source in the form of an electrically heated element 21, a convection means in the form of an electric fan 23, for moving air that has been heated by the heating element 21, and a nozzle 25 for directing a stream of heated air toward the area underneath the heated nozzle 11 of the extruder 5. The heated element 21 and fan 23 are located within a housing 27 comprising an air inlet 29, and an air outlet 31 in connection with the nozzle 25. In use, air is drawn in through the air inlet 29 by the fan 23 where it then passes across or through the heating element 21 and then exits the air outlet 31 via the nozzle 25.

It will be appreciated that by directing high temperature air to the area underneath the hot end-nozzle 11, that the lower printed layer of material forming the substrate for the upper layer of material will be pre-heated in that region prior to the upper layer of material being deposited, resulting in greater bonding or adhesion between adjacent layers.

In use, for example, with PEEK filament, which has a glass transition temperature of approximately 143° C., a melting temperature of approximately 343° C. and a continuous use temperature of 240° C. to 260° C., the heating means 20 will be heating the lower layer to a temperature of around 160° C. to 300° C., and the extruder 5 will be heating and depositing the upper layer at a temperature of around 380° C. to 500° C. It will be appreciated that by sufficiently pre-heating the lower layer of material, the temperature of the upper layer of material deposited upon the lower layer of material will be sufficient to heat the lower layer of material enough that it at least partially melts or softens sufficiently such that the two layers of material will form a strong bond.

It will further be appreciated that by varying parameters such as the temperature of the heating element 21, the speed of the fan 23, or the size or shape of the heater nozzle 25, that the characteristics of the air being delivered toward the substrate can be modified as required to suit the properties of the material being printed. In some circumstances, it may be necessary to cool the substrate rather than heat it. For instance, if the printed layer is being stretched or bridged across a gap and quick cooling of the layer is required to prevent sagging or dipping of the printed layer. In such a circumstance, the heating element 21 may be turned off and the fan 23 used to direct cool, instead of hot air toward the printed layer.

The heating means 20 may also feature a sensor (not shown) used to measure the temperature of the lower layer or substrate, in order to provide a feedback loop to the heating element 21 and/or fan 23in order to maintain the desired temperature of the substrate.

It will be appreciated that by locally heating the lower layer immediately prior to printing the upper layer, that less energy is required than heating and maintaining the heat in an entire chamber, and as a result, the cold end of the extruder driving the unmelted filament, and the control system motors and associated electronics used to control the position of the extruder 5 relative to the platform (not shown) are not exposed to elevated temperatures created by having to heat the entire chamber.

It will further be appreciated that by only heating the area of the workpiece that is about to become the substrate for a new layer of material, that the entire workpiece does not have to be subjected to elevated temperatures.

It will also be appreciated that by only heating a small area of the workpiece, rather than the entire chamber, that the small area of the workpiece can be heated to temperatures substantially higher than those achievable if the entire chamber were to be heated.

It will also be appreciated that if the area of the workpiece underneath the nozzle is heated to a temperature in excess of its glass transition temperature, that the workpiece will become compliant or soft. In the event that an overextrusion of the lower layer occurs, the lower layer may be soft enough for the hot-end nozzle to pass over, coming in to contact with the lower layer, without dislodging or moving the workpiece from the printing bed.Referring now to FIG. 3, where there is shown a cross-sectional schematic of a portion of a 3D printer according to an alternative embodiment, where the printer comprises the same extruder 5 as shown in FIG. 2, but comprises an alternative heating means, where the fan 23 and air inlet 29 are not located within the housing 27, and are instead located remote from the heater element 21 and in fluid connection with the heater housing 27 via a flexible conduit 33.

In yet another alternative embodiment (not shown) the heat source and convection means may all be located remote from the heater nozzle, such that only the heater nozzle is located adjacent to the extruder for heating an area directly below the heated nozzle.

It will be appreciated that remotely locating a number of the heating components away from the extruder results in a decrease in the overall size and weight of the assembly, placing less load on, or requiring lower spec, or less power intensive motors used to control the position of the extruder relative to the print bed.

In yet another alternative embodiment (not shown) a single heat source may be employed to heat the heated nozzle and to supply heat to the heater nozzle.

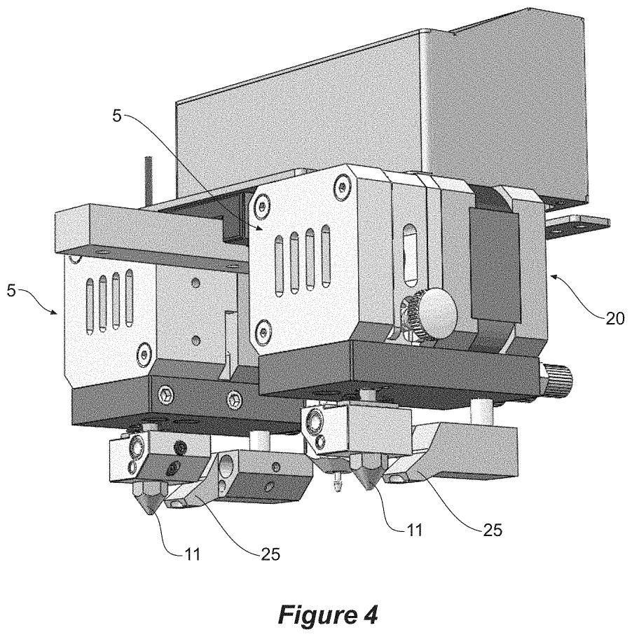

Referring now to FIG. 4, there is shown a perspective view of a portion of a 3D printer, according to yet another alternative embodiment, where the printer comprises two extruders 5 and two complementary heating means and heated nozzles 25 configured to heat the substrate in an area underneath the heated nozzle 11 of each extruder 5.

While in the embodiments described, the heating means has been in the form of an electric element, fan and nozzle, it will be appreciated that any other suitable heating means capable of heating the area beneath the nozzle could be employed. For example, the heating means may be in the form of a laser or an infrared emitter configured to heat the area beneath the nozzle.Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A 3D printer comprising:
an extruder comprising a heated nozzle for depositing a layer of molten material on to a substrate; and
a heating means configured to heat the substrate in an area underneath the heated nozzle of the extruder.

2. The 3D printer as claimed in claim 1, wherein the heating means comprises a heat source and a convection means, wherein the convection means directs heated air that has been heated by the heating source toward the area underneath the heated nozzle of the extruder.

3. The 3D printer as claimed in claim 2, wherein the heating means further comprises a heater nozzle, configured to direct a stream of heated air toward the area underneath the heated nozzle of the extruder.

4. The 3D printer as claimed in claim 3, wherein the heater nozzle is located adjacent to the heated nozzle.

5. The 3D printer as claimed in claim 1 wherein the heat source is an electrically heated element.

6. The 3D printer as claimed in claim 2, wherein the convection means comprises a fan.

7. The 3D printer as claimed in claim 6, wherein the fan is located adjacent to the heat source.

8. The 3D printer as claimed in claim 6, wherein the fan is located remote from the heat source and is in fluid connection with the heating element via a conduit.

9. The 3D printer as claimed in claim 1, wherein the heating means is in the form of a laser configured to heat the area underneath the heated nozzle of the extruder.

10. The 3D printer as claimed in claim 1, wherein the heating means is in the form of an infrared emitter configured to heat the area underneath the heated nozzle of the extruder.

11. The 3D printer as claimed in claim 1, wherein the heating means further comprises a sensor to measure the temperature of the substrate in the area underneath the heated nozzle of the extruder, in order to provide a feedback loop to the heating means in order to maintain a desired temperature of the substrate.
